(19) United States
(12) Patent Application Publication
(10) Pub. No.: US 2017/0168218 A1
(43) Pub. Date: Jun. 15, 2017

(54) BACKLIGHT MODULE, DISPLAY MODULE, AND DISPLAY DEVICE

(71) Applicants: Le Holdings(Beijing)Co., Ltd., Beijing (CN); LE SHI ZHI XIN ELECTRONIC TECHNOLOGY (TIAN JIN) LIMITED, Tianjin (CN)

(72) Inventor: Changjia Fu, Tianjin (CN)

(21) Appl. No.: 15/244,768

(22) Filed: Aug. 23, 2016

Related U.S. Application Data
(63) Continuation of application No. PCT/CN2016/088992, filed on Jul. 6, 2016.

(30) Foreign Application Priority Data
Dec. 10, 2015 (CN) 201521029436.X

(51) Int. Cl. F21V 8/00

(52) U.S. Cl. CPC G02B 6/0031; G02B 6/0088; G02B 6/0068; G02B 6/0055

(57) ABSTRACT

The application provides a backlight module, a display module, and a display device. The backlight module includes: a back cover including an accommodating space; a reflector, a light guide plate, and an optical sheet arranged in order in the accommodating space of the back cover; LED bars located in the accommodating space of the back cover at the light incidence side of the light guiding late, wherein LED bars include a plurality of LEDs; and a mold frame located above the optical sheet and connected with the back cover; wherein the backlight module further includes: a plurality of light absorbing layer structures and a plurality of light reflecting layer structures arranged between the optical sheet and the mold frame, where orthographic projections of the light absorbing layers onto the bottom plate of the back cover face orthographic projections of the LEDs on the bottom plate of the back cover, and orthographic projections of the light reflecting layers onto the bottom plate of the back cover face orthographic projections of gaps between adjacent LEDs onto the bottom plate of the back cover. The light absorbing layer structures can absorb a part of light rays at bright strips, and the light reflecting layer structures can reflect a part of light rays emitted from the optical sheet back to dark strips so that the light rays at the light incidence side of the backlight module can become more uniform as a whole to thereby weaken the phenomenon of lamp shadow in effect so as to improve the quality of a picture in the display device.

### CROSS REFERENCE TO RELATED APPLICATIONS

This application is a continuation of International Application No. PCT/CN2016/088992, filed on Jul. 6, 2016, which is based upon and claims priority to Chinese Patent Application No. 201521029436.X, filed on Dec. 10, 2015, the entire contents of which are incorporated herein by reference.

### TECHNICAL FIELD

The disclosure relates to the field of display technologies, and particularly to a backlight module, a display module, and a display device.

### BACKGROUND

At present, Light Emitting Diodes (LEDs) are commonly used as light sources in a backlight module of a liquid crystal display device. The backlight module can be categorized into a backlight module of side light type and a backlight module of straight down type, dependent upon the positions where the light sources are distributed, where strips of LED lamps in the backlight module of side light type are located at side ends of a light guide plate, and such a backlight module is generally applicable to a notebook PC, a palm PC, a handset, or another display device with a small size. As the LED related technologies are developing constantly, the backlight module of side light type is also coming to be applicable to a display device with a large size to thereby bring a better visual experience of a user.

The structure of the backlight module of side light type generally includes: a back cover including an accommodating space; a reflector, a light guide plate, and an optical sheet arranged in order in the accommodating space of the back cover; and LED bars located in the accommodating space of the back cover at the light incidence side of the light guide plate; and a mold frame located above the optical sheet and connected with the back cover, where the back cover 10, the light guide plate 11, and the LED bars 12 are structured as illustrated in FIG. 1.

In the prior art, since LEDs in the LED bars 12 emit light at a limited angle, as illustrated in FIG. 1, there are such strong light rays in the area facing each LED that a bright strip A1 at high brightness is formed in the area facing the LED, and a dark strip A2 at low brightness is formed in the area facing the gap between two adjacent LEDs, thus resulting in the phenomenon of alternating bright and dark strips, which is referred to as lamp shadow. The quality of a picture displayed on the display device may be degraded due to the lamp shadow.

### SUMMARY

Embodiments of the application provide a backlight module, a display module, and a display device so as to weaken the phenomenon of lamp shadow in the backlight module, and further improve the quality of a picture displayed on the display device.

An embodiment of the application provides a backlight module including: a back cover including an accommodating space; a reflector, a light guide plate, and an optical sheet arranged in order in the accommodating space of the back cover; LED bars located in the accommodating space of the back cover at the light incidence side of the light guide plate, wherein LED bars includes a plurality of LEDs; and a mold frame located above the optical sheet and connected with the back cover; wherein the backlight module further includes:
a plurality of light absorbing layer structures and a plurality of light reflecting layer structures arranged between the optical sheet and the mold frame, where orthographic projections of the light absorbing layer structures onto the bottom plate of the back cover face orthographic projections of the LEDs on the bottom plate of the back cover, and orthographic projections of the light reflecting layer structures onto the bottom plate of the back cover face orthographic projections of gaps between adjacent LEDs onto the bottom plate of the back cover.

An embodiment of the application provides a display module including the backlight module according to any one of the technical solutions above. There are such uniform light rays at the light incidence side of the backlight module of the display module that the quality of a picture is high, so there is a good effect of displaying the picture on the display module.

An embodiment of the application provides a display device including the display module according to the technical solution above. The display device has a high quality of a picture, and a good effect of displaying the picture.

Optionally the display device includes a liquid crystal TV set, a liquid crystal display, or a display screen of a handset.

### BRIEF DESCRIPTION OF THE DRAWINGS

In order to make the technical solutions according to the embodiments of the application or in the prior art more apparent, the drawings to which a description of the embodiments or the prior art refers will be briefly introduced below, and apparently the drawings to be described below are merely illustrative of some of the embodiments of the application, and those ordinarily skilled in the art can derive from these drawings without any inventive effort.

One or more embodiments are illustrated by way of example, and not by limitation, in the figures of the accompanying drawings, wherein elements having the same reference numeral designations represent like elements throughout. The drawings are not to scale, unless otherwise disclosed. In the drawings:

FIG. 1 is a schematic structural diagram of the backlight module in the prior art;

FIG. 2 is a schematic diagram of a top view of a backlight module according to some embodiments of the application; and

FIG. 3 is a schematic diagram of a cross section of a display module according to some embodiments of the application;

### REFERENCE NUMERALS

10—Back cover

11—Light guide plate

12—LED bar

120—Heat sink

121—Substrate

122—LED

13—Light rays emitted by the LED

14—Mold frame

15—Optical sheet

16—Liquid crystal panel

17—Bezel

18—Reflector

21—Light absorbing layer structure

22—Light reflecting layer structure

A1—Bright strip

A2—Dark strip

### DETAILED DESCRIPTION

In order to make the objects, technical solutions, and advantages of the embodiments of the application more apparent, the technical solutions according to the embodiments of the application will be described below clearly and fully with reference to the drawings in the embodiments of the application, and apparently the embodiments described below are only a part but not all of the embodiments of the application. Based upon the embodiments here of the application, all the other embodiments which can occur to those skilled in the art without any inventive effort shall fall into the scope of the application.

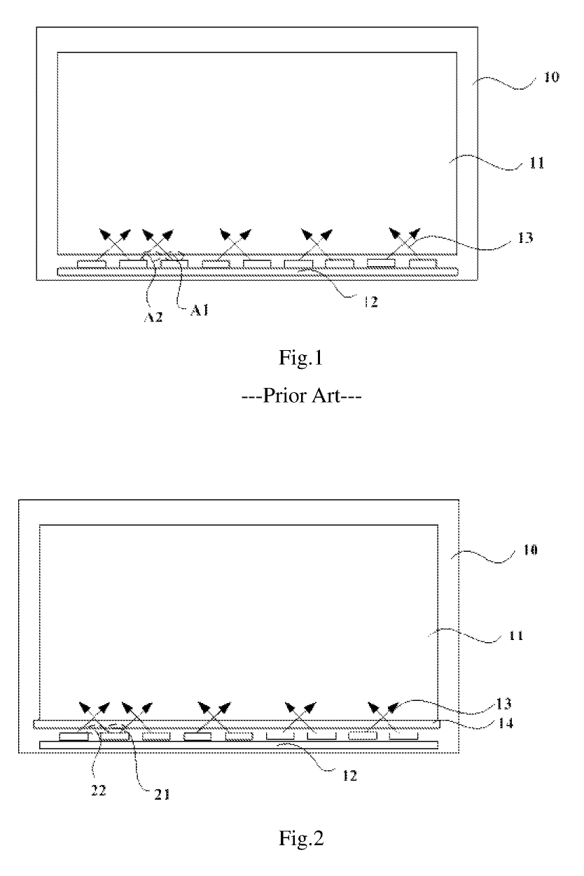

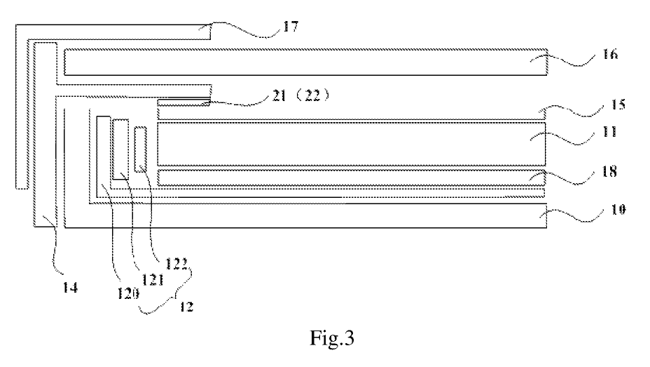

As illustrated in FIG. 2 and FIG. 3, a backlight module according to an embodiment of the application includes: a back cover 10 including an accommodating space; a reflector 18, a light guide plate 11, and an optical sheet 15 arranged in order in the accommodating space of the back cover 10; LED bars 12 located in the accommodating space of the back cover 10 at the light incidence side of the light guiding late 11, where LED bars include a plurality of LEDs 122; and a mold frame 14 located above the optical sheet 15 and connected with the back cover 10; and the backlight module further includes:

A plurality of light absorbing layers 21 and a plurality of light reflecting layer structures 22 arranged between the optical sheet 15 and the mold frame 14, where orthographic projections of the light absorbing layer structures onto the bottom plate of the back cover face orthographic projections of the LEDs on the bottom plate of the back cover, and orthographic projections of the light reflecting layer structures onto the bottom plate of the back cover face orthographic projections of gaps between adjacent LEDs onto the bottom plate of the back cover.

Here the LED bars 12 include heat sinks 120, substrates 121, and a plurality of LEDs 122.

Referring to FIG. 2, the LED bars 12 are located at the light incidence side of the light guide plate 11, and as can be apparent seen from an optical path of light emitted by the LEDs, there are strong light rays 13 emitted by the LEDs directly in front of the LEDs, and weak light rays of the LEDs in the areas directly in front of the areas between every two adjacent LEDs; and it shall be noted that “directly in front of the LEDs” as referred to here the orthographic projection direction of the LEDs perpendicular to the light incidence end face of the light guide plate, similarly, “directly in front of the areas between every two adjacent LEDs” refers to the orthographic projection direction of the areas between every two adjacent LEDs perpendicular to the light incidence end face of the light guide plate.

In an embodiment, there are a plurality of light absorbing layer structures and a plurality of light reflecting structures arranged between the optical sheet and the mold frame 14, where orthographic projections of the light absorbing layer structures onto the bottom plate of the back cover face orthographic projections of the LEDs onto the bottom plate of the back cover, and the light absorbing layer structures can absorb a part of light rays at bright strips in a lamp shadow area to thereby weaken the light rays at the bright strips in a lamp shadow area; and orthographic projections of the light reflecting layer structures onto the bottom plate of the back cover face orthographic projections of the gaps between every two adjacent LEDs onto the bottom plate of the back cover, and the light reflecting layer structures can reflect light rays exiting the light guide plate and the optical sheet back to dark strips in the lamp shadow area to thereby intensify the light rays at the dark strips in the lamp shadow area. With this design, the light rays at the light incidence side of the backlight module can become more uniform to thereby weaken the phenomenon of lamp shadow in effect so as to improve the quality of a picture in the backlight module, and further an effect of displaying the picture on a display device.

Here the light absorbing layer structures will not be limited to any particular type of structure, for example, they can be light absorption adhesive tapes or light absorbing film layers; and alike the light reflecting layer structures will not be limited to any particular type of structure, for example, they can be light reflection adhesive tapes or light reflecting film layers.

If the light absorbing layer structures are light absorption adhesive tapes, and the light reflecting layer structures are light reflection adhesive tapes, then the light absorption adhesive tapes and the light reflection adhesive tapes can be structured integral. The light absorbing layers and the light reflecting layers can be arranged alternately on the same adhesive tape to thereby simplify a process of assembling the backlight module so as to improve the efficiency of producing the backlight module. Of course, the respective absorption adhesive tapes and light reflection adhesive tapes can alternatively be shaped in blocks arranged alternately between the optical sheet and the mold frame so that orthographic projections of the absorption adhesive tapes shaped in blocks onto the bottom plate of the back cover face orthographic projections of the LEDs onto the bottom plate of the back cover, and orthographic projections of the light reflection adhesive tapes shaped in blocks onto the bottom plate of the back cover face orthographic projections of the gaps between the adjacent LEDs onto the bottom plate of the back cover.

If the light absorbing layer structures are light absorbing film layers, and the light reflecting layer structures are light reflecting film layers, then the light absorbing film layers and the light reflecting film layers will be arranged alternately on the inner side of a front wall of the mold frame.

As illustrated in FIG. 3, an embodiment of the application provides a display module including the backlight module according to any one of the technical solutions, where the display module further includes a bezel 17, and a liquid crystal panel 16 arranged between the bezel 17 and the backlight module. There are such uniform light rays at the light incidence side of the backlight module of the display module that the quality of a picture is high, so there is a good effect of displaying the picture on the display module.

An embodiment of the application provides a display device including the display module according to the technical solution above. The display device has a high quality of a picture, and a good effect of displaying the picture.

In an embodiment of the application, the display device includes a liquid crystal TV set, a liquid crystal display, or a display screen of a handset.

Lastly it shall be noted that the respective embodiments above are merely intended to illustrate but not to limit the technical solution of the application; and although the application has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the application as claimed.

What is claimed is:

1. A backlight module, comprising: a back cover comprising an accommodating space; a reflector, a light guide plate, and an optical sheet arranged in order in the accommodating space of the back cover; LED bars located in the accommodating space of the back cover at the light incidence side of the light guiding late, wherein LED bars comprise a plurality of LEDs; and a mold frame located above the optical sheet and connected with the back cover; wherein the backlight module further comprises:
a plurality of light absorbing layer structures and a plurality of light reflecting layer structures arranged between the optical sheet and the mold frame, where orthographic projections of the light absorbing layers onto the bottom plate of the back cover face orthographic projections of the LEDs on the bottom plate of the back cover, and orthographic projections of the light reflecting layers onto the bottom plate of the back cover face orthographic projections of gaps between adjacent LEDs onto the bottom plate of the back cover.

2. The backlight module according to claim 1, wherein the light absorbing layer structures are light absorption adhesive tapes, and the light reflecting layer structures are light reflection adhesive tapes.

3. The backlight module according to claim 2, wherein the light absorbing layer structures and the light reflecting layer structures are structured integral.

4. The backlight module according to claim 1, wherein the light absorbing layer structures are light absorbing film layers arranged on the inner side of a front wall of the mold frame, and the light reflecting layer structures are light reflecting film layers arranged on the inner side of the front wall of the mold frame.

5. A display module, comprising a backlight module, wherein the backlight module comprises a back cover comprising an accommodating space; a reflector, a light guide plate, and an optical sheet arranged in order in the accommodating space of the back cover; LED bars located in the accommodating space of the back cover at the light incidence side of the light guiding late, wherein LED bars comprises a plurality of LEDs; and a mold frame located above the optical sheet and connected with the back cover; wherein the backlight module further comprises:
a plurality of light absorbing layer structures and a plurality of light reflecting layer structures arranged between the optical sheet and the mold frame, where orthographic projections of the light absorbing layers onto the bottom plate of the back cover face orthographic projections of the LEDs on the bottom plate of the back cover, and orthographic projections of the light reflecting layers onto the bottom plate of the back cover face orthographic projections of gaps between adjacent LEDs onto the bottom plate of the back cover.

6. The display module according to claim 5, wherein the light absorbing layer structures are light absorption adhesive tapes, and the light reflecting layer structures are light reflection adhesive tapes.

7. The display module according to claim 6, wherein the light absorbing layer structures and the light reflecting layer structures are structured integral.

8. The display module according to claim 5, wherein the light absorbing layer structures are light absorbing film layers arranged on the inner side of a front wall of the mold frame, and the light reflecting layer structures are light reflecting film layers arranged on the inner side of the front wall of the mold frame.

9. A display device, comprising a display module, wherein the display module comprises a backlight module, and the backlight module comprises a back cover comprising an accommodating space; a reflector, a light guide plate, and an optical sheet arranged in order in the accommodating space of the back cover; LED bars located in the accommodating space of the back cover at the light incidence side of the light guiding late, wherein LED bars comprise a plurality of LEDs; and a mold frame located above the optical sheet and connected with the back cover; wherein the backlight module further comprises:
a plurality of light absorbing layer structures and a plurality of light reflecting layer structures arranged between the optical sheet and the mold frame, where orthographic projections of the light absorbing layers onto the bottom plate of the back cover face orthographic projections of the LEDs on the bottom plate of the back cover, and orthographic projections of the light reflecting layers onto the bottom plate of the back cover face orthographic projections of gaps between adjacent LEDs onto the bottom plate of the back cover.

10. The display device according to claim 9, wherein the display device comprises a liquid crystal TV set, a liquid crystal display, or a display screen of a handset.

11. The display device according to claim 9, wherein the light absorbing layer structures are light absorption adhesive tapes, and the light reflecting layer structures are light reflection adhesive tapes.

12. The display device according to claim 11, wherein the light absorbing layer structures and the light reflecting layer structures are structured integral.

13. The display device according to claim 9, wherein the light absorbing layer structures are light absorbing film layers arranged on the inner side of a front wall of the mold frame, and the light reflecting layer structures are light reflecting film layers arranged on the inner side of the front wall of the mold frame.
